(19) United States
(12) Patent Application Publication
(10) Pub. No.: US 2021/0289171 A1
(43) Pub. Date: Sep. 16, 2021

(54) IMAGE TRACKING OBJECTS ASSOCIATED WITH OBJECTS OF INTEREST

(71) Applicant: HEWLETT PACKARD ENTERPRISE DEVELOPMENT LP, Houston, TX (US)

(72) Inventor: Soumyendu Sarkar, San Jose, CA (US)

(21) Appl. No.: 16/814,454

(22) Filed: Mar. 10, 2020

(51) Int. Cl. H04N 7/18; G08B 31/00; G06K 9/00

(52) U.S. Cl. CPC H04N 7/181; G08B 31/00; H04N 7/183; G06K 9/00335; G06K 9/00771

(57) ABSTRACT

Example implementations relate to tracking, by at least one image capture device, an object associated with an object of interest. An object of interest may be identified. The object of interest may be tracked, and one or more objects may be associated with the object of interest based on an interaction between the object of interest and the one or more associated objects. Subsequently, the object associated with the object of interest may be tracked.

### BACKGROUND

Camera-enabled security systems may be used to monitor a particular area covered by a field of view of a camera of the security system. A viewer, such as a security guard, may monitor this field of view for suspicious activity occurring within the particular area, or suspicious persons within the particular area. The video and/or audio captured by any camera of the security system may be transmitted wirelessly, and any number of cameras may be implemented within the security system. The overall field of view of a security system may be increased through the use of multiple security cameras. For example, cameras of a security system may be installed at different locations having different field of views or otherwise different perspectives and/or viewing angles. Cameras of a security system may be installed at different locations around or near a particular area to cover an area of interest larger than the field of view of any one camera of the security system, and/or such that a first camera of the security system may cover a “blind spot” of a second camera of the security system.

### BRIEF DESCRIPTION OF THE DRAWINGS

Certain examples are described in the tracking detailed description and in reference to the drawings, in which:

FIG. 1 is a block diagram illustrating a system for tracking an object associated with an object of interest.

FIGS. 2A and 2B are block diagrams illustrating example systems for tracking objects responsive to an event.

FIG. 3 is a block diagram illustrating a system for generating an alert responsive to an event.

FIG. 4 is a block diagram illustrating an example non-transitory computer readable medium storing example instructions thereon for tracking one or more objects associated with an object of interest.

FIG. 5 is a block diagram illustrating an example system for tracking one or more objects associated with an object of interest.

FIG. 6 is a flowchart illustrating an example method for tracking one or more objects associated with an object of interest.

FIG. 7 is a flowchart illustrating another example method for tracking one or more objects associated with an object of interest.

### DETAILED DESCRIPTION OF SPECIFIC EXAMPLES

Examples described herein relate to systems and/or methods for tracking an object associated with an object of interest, such as a person of interest. A person of interest may be, for example, an individual being investigated or otherwise monitored by police or other security persons, and/or a person identified as having conducted suspicious activity. Suspicious activity may be a predetermined action or event associated with, or otherwise conducted by an object. An object, as referred to herein, may be any person, animal, or thing that can be interpreted as a unit for purposes of image processing.

An object of interest may be tracked by one or more image capture devices of a security system. An object may be tracked, for example, by locating, via one or more image capture devices of a security system, the position and/or orientation of the object within one or more fields of view over a period of time. An object of interest may be tracked for any number of reasons, which include but are not limited to, dispatching law enforcement to a location associated with the location of the object of interest, monitoring activity associated with the object of interest, and/or preventing a volatile, dangerous or otherwise undesirable situation from occurring.

In some examples, tracking an object of interest alone may not be sufficient to satisfy these reasons. For example, the object of interest may be travelling in a crowded or otherwise occluded area where the location of the object of interest at any given moment may not be identifiable from a field of view of an image capture device. Furthermore, the object of interest may be working in collusion with other associated persons, and/or may possess, deploy, or transfer objects that may cause a security threat or other illegal or undesirable action.

Objects associated with an object of interest may be identified and/or tracked to monitor any potential threat posed by the associated objects. Computer vision techniques may be implemented and processed to identify associated objects, and monitor the associated objects or otherwise flag any suspicious event or activity associated with the identified associated objects.

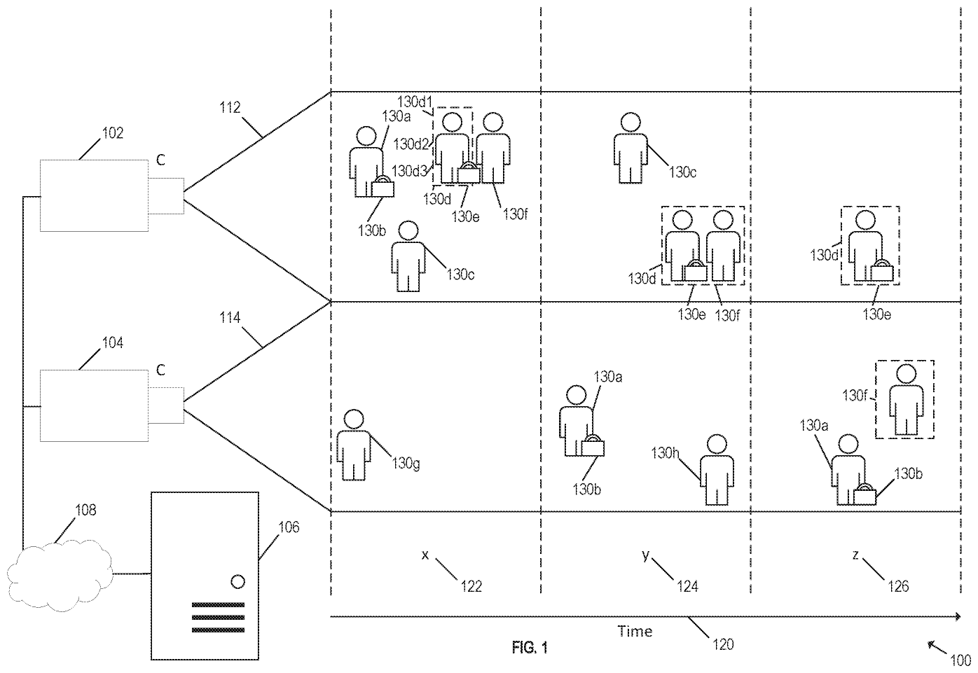

FIG. 1 is a block diagram illustrating a system 100 for tracking an object associated with an object of interest. System 100 may include example image capture device 102 and example image capture device 104. Image capture device 102 and/or image capture device 104 may be a security camera, video recorder, and/or any other device for capturing a time sequence of images. In an example implementation, image capture device 102 may be disposed and/or otherwise positioned to have a first field of view 112. Similarly, image capture device 104 may be disposed and/or otherwise positioned to have a second field of view 114. A “field of view” of an image capture device as described herein may be an area observable by the image capture device at a given time. The field of view may depend on a number of factors including the positioning, orientation, and specifications of the image capture device. Objects outside the field of view of an image capture device at a given time may not be captured, detected, or otherwise recorded by the image capture device at that given time. As described above, each image capture device of security system 100 may be installed at different locations around or near a particular area to cover an area of interest larger than the field of view of any one image capture device of the security system, and/or such that a first camera of the security system may cover a “blind spot” of a second camera of the security system.

In some examples, image capture devices 102 and 104 respectively may be placed at different viewing angles, may cover a same area for purposes of redundancy, and/or may be placed such that each of image capture devices 102 and 104 cover overlapping fields of view. Additionally, while two example image capture devices, 102 and 104 respectively, are included in security system 100 for purposes of clarity and conciseness, any number of image capture devices may be implemented.

Image capture devices 102 and 104 may, in some examples, be in communication with a like server, e.g. server 106. Specifically, image capture device 102 and/or image capture device 104 may transmit image data captured by image capture devices 102 and/or 104 to server 106. In an example, server 106 may store image data received by image capture devices 102 and/or 104, and/or may otherwise process and/or develop insights from the stored data. Server 106 may otherwise store the image data as video streams of data and may further store complementary tracking metadata. The data may be stored at a searchable database and/or as any other data structure enabling the query, playback, and/or analysis of the data. Server 106 may be local to image capture devices 102 and/or image capture device 104, or may be remote to image capture device 102 and/or image capture device 104. For instance, server 106 may be accessed remotely over a network. In an example, image capture devices 102 and 104 may transmit data to server 106 via cloud 108.

Cloud 108 may be any number of network devices for transmitting data received by any of image capture devices 102 or 104 to server 106. Server 106 may be a “cloud-based” server, which may include any number of servers disposed at any number of locations in communication with each other and accessible over a network. For example, while server 106 is illustrated as a single device for purposes of clarity and conciseness, server 106 may include any number of devices to store and/or otherwise process any combination of data received by image capture devices 102 and/or 104 respectively.

Image capture devices 102 and 104 may capture a time sequence 120 of images at the respective field of view of each of image capture devices 102 and 104. A time sequence of images may be a series of images taken in succession (often rapid succession), within a period of time. For example, as illustrated at FIG. 1, image capture device 102 and image capture device 104 may each capture a time sequence of images, including an image captured at time slice x 122, time slice y 124, and time slice z 126. While three examples time slices are illustrated for purposes of clarity and conciseness, any number of images may be captured within a period of time. For example, image capture device 102 and/or image capture device 104 may capture tens of images per second or even hundreds of images per second (often measured as frames-per-second “FPS”).

Image capture device, as described above, may capture any number of objects. An object, as referred to herein, may be any person or thing that can be interpreted as a unit for purposes of image processing. However, for purposes of clarity and conciseness, objects 130a-122g are illustrated herein as examples. These objects may be captured, for example, at a high security area, such as an airport, and may include persons and/or the possessions of persons traversing the airport. Starting at example time slice x 122, example objects 130a-130f are illustrated as captured at field of view 112 of image capture device 102, and example object 130g is illustrated as captured at field of view 114 of image capture device 104.

An object of interest may be identified by security system 100. As described above, an object of interest may be a person of interest, for example an individual being investigated or otherwise monitored by police or other security persons, and/or a person identified as having conducted suspicious activity. In some example implementations, an object of interest may be pre-identified. For example, specific features of an object of interest may be stored at server 106 and an object matching those features may be identified by image captures device 102 and/or image capture device 104 via image detection algorithms. In another example implementation, server 106 may store any number of actions or activities (as will further be described below) that when executed by any of objects 130a-130g, will identify the executing object as an object of interest.

In an example implementation, server 106 may conduct machine learning techniques, such as deep learning object detection algorithms, face analytics, time-series analysis, computer vision techniques, object detection algorithms, any combination thereof, and/or any other learning algorithms for identifying an object as an object of interest. In this illustrated example, person 130d may be identified at time slice x 122 as an object of interest.

System 100 may track person 130d, as indicated by the dashed-line box surrounding person 130d. In this illustrated example, person 130d may be tracked responsive to being identified as an object of interest for any of the reasons described above. In some examples, system 100 may “track” an object by monitoring the direction, position, speed, and/or any number of other attributes of the tracked object over a period of time. In an example implementation, the motions of a tracked object may be learned and further predicted based on historical data, such that the tracked object may be located quickly and automatically as the object moves through the area of interest. As illustrated in FIG. 1, object of interest 130d, and specifically the movement of object of interest 130d, may be tracked across time sequence 120, as indicated by the images captured at time slice x 122, time slice y 124, and time slice z 126.

In some example implementations, an object of interest may be tracked as a connected model of key points associated with the object of interest. Key points may include body parts, joints, key distinguishing features, and or any other significant points for tracking an object of interest. Key points 130d1-d3 are example key points of example object of interest 130d. By tracking key points 130d1-d3 of object of interest 130d, object of interest 130d may be tracked with greater accuracy and precision. Additionally, specific actions and/or movements of object 130d may be tracked and otherwise recorded at server 106. For example, a movement of the head 130d1 of object 130d, such as a head nod, may be tracked, and may be recorded as input to system 100. As another example, hand 130d3 may be tracked and may be monitored for contact with other objects, e.g. object 130e and/or object 130f.

In an example, one or more objects associated with object of interest 130d may be identified. In the example illustrated at FIG. 1, objects 130e and 130f may be identified as associated with object of interest 130d at time slice y 124. Objects 130e and/or 130f may for example, have a social association with object 130d, i.e. be a friend, family member, associate, accomplice, travel companion, and/or any other person having a social association with object of interest 130d. In some examples, objects 130e and/or 130f may be a belonging or other object being carried and/or worn by object of interest 130d, such as luggage, clothing, etc.

In an example implementation, system 100 may utilize computer vision techniques, such as deep learning object detection algorithms, face analytics, key point analysis, and/or time series analysis of scene progressions adapted by computer vision algorithms to identify objects 130e and/or objects 130f as associated with object of interest 130d. An object may, in some examples, be identified as associated with an object of interest based on an interaction of the object of interest with the associated object. Specifically, the association of objects may be identified, for example, by actions, movement patterns, and/or positioning patterns exhibited by object 130d, and in some examples by key points 130d1-d3 of object 130d, relative to objects 130e and/or objects 130f. For example, system 100 may use deep learning object detection algorithms to identify an association between objects according to a relative proximity and/or contact between objects over a period of time; by analyzing the actions taken between objects, e.g. a hand gesture, an embrace, a passing of a belonging, etc.; the length of time the objects are captured within a like field of view, and/or any number of other learned association patterns between objects.

System 100, upon identifying one or more objects associated with the object of interest, may track the one or more objects associated with the object of interest. When events occur that threaten security for instance, the tracking of objects associated with an object of interest, in addition to tracking the object of interest, may aid in the containment and/or mitigation of a potential volatile or otherwise dangerous situation. Specifically, the tracking of associated objects may diffuse the threat posed by, or accelerate the identification of, accomplices of the object of interest, or any number of belongings of the object of interest that may pose a threat to public safety, such as contraband, weapons, hazardous chemicals, etc.

In an example implementation, tracking the one or more objects associated with the object of interest may include following the one or more associated objects across a second field of view where the one or more associated objects leave the first field of view. In an example, the one or more associated objects may be tracked at a second field of view even if the object of interest is not disposed within the second field of view. Turning to time slice z of the illustrated example, associated object 130f may be tracked even after leaving first field of view 112 of image capture device 102 and entering second field of view 114 of image capture device 104. Accordingly, any number of objects associated with an object of interest may be simultaneously tracked at different fields of view from a tracked object of interest.

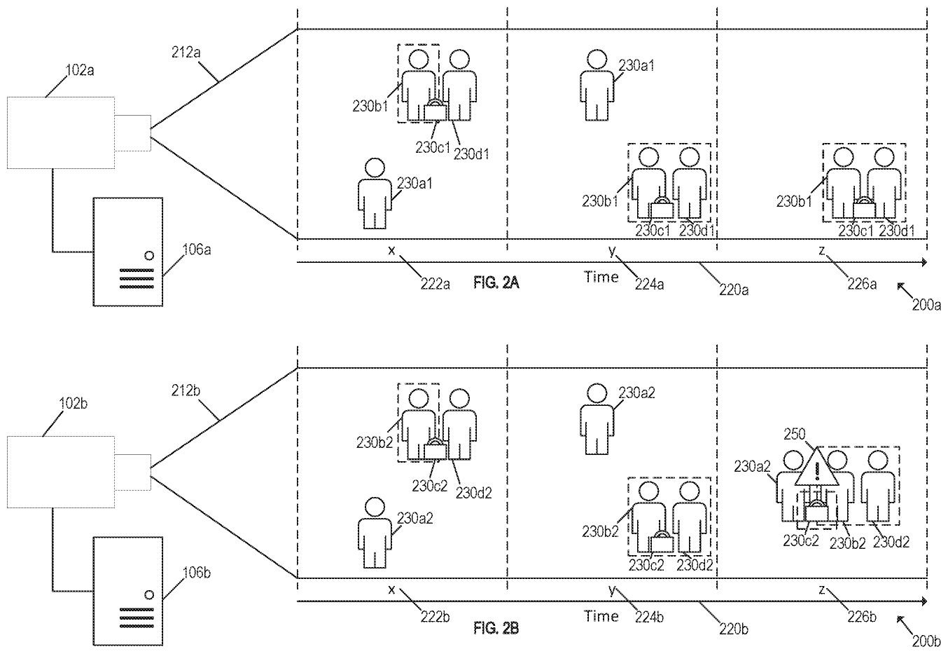

FIG. 2A and FIG. 2B are block diagrams illustrating example systems 200a and 200b respectively, for tracking objects responsive to an event. System 200a and system 200b may include similar architecture to that described above with respect to FIG. 1, including image capture device 102, illustrated at FIG. 2A and FIG. 2B as 102a and 102b respectively, and server 106 illustrated at FIG. 2A and FIG. 2B as 106a and 106b respectively. Image capture device 102a may be disposed and/or otherwise positioned to have a field of view 212a. Similarly, image capture device 102b may be disposed and/or otherwise positioned to have a field of view 212b.

Image capture device 102a and 102b, like image capture device 102 as described above, may capture a time sequence (220a and 220b respectively) of images at the respective field of view of each of image capture device 102a and 102b. As described above, a time sequence of images may be a series of images taken in succession (often rapid succession), within a period of time. As illustrated at FIG. 2a and FIG. 2b, image capture device 102a and image capture device 102b may each capture a time sequence of images, including an image captured at time slice x (222a and 222b respectively), time slice y (224a and 224b respectively), and time slice z (226a and 226b respectively).

Image capture device 102a, similar to image capture device 102 as described above with respect to FIG. 1, may capture images of objects within the image capture device's respective field of view. At time slice x 222a, image capture device is illustrated as capturing objects 230a1-d1. System 200a may, similar to system 100 as described above with respect to object 130d, track person 230b1. Object 230b1, and specifically the movement of object 230b1, may be tracked across time sequence 220a, as indicated by the images captured at time slice x 222a, time slice y 224a, and time slice z 226a.

In an example, one or more objects associated with tracked object 230b1 may be identified. At example time slice y 224a illustrated at FIG. 2A, objects 230c1 and 230d1 may be identified as associated with tracked object 230b1. Object 230c1 may be a belonging or other object being carried and/or worn by object of interest 230b1, such as luggage, clothing, etc. Object 230d1 may for example, have a social association with object 230b1, i.e. be a friend, family member, associate, accomplice, travel companion, and/or any other person having a social association with object of interest 230b1.

In the example illustrated at FIG. 2A, image capture device may capture an image at example time slice z 226a of object 230b1 passing object 230c1 to object 230d1. In an example implementation, system 200a may track object 230d1 and/or object 230c1 responsive to the passing of object 230c1 from object 230b1 to object 230d1. In an example, system 200a may not generate an alert responsive to the passing of object 230c1 from object 230b1 to object 230d1 because object 230d1 was determined to be associated with object 230d1 at time slice y 224a.

Turning to system 200b, image capture device 102b may capture images of objects within the image capture device's field of view 212b. At time slice x 222b, image capture device is illustrated as capturing an image of objects 230a2-d2. System 200b may track person 230b2. Object 230b2, and specifically the movement of object 230b2, may be tracked across time sequence 220b, as indicated by the images captured at time slice x 222b, time slice y 224b, and time slice z 226b.

In an example, one or more objects associated with tracked object 230b2 may be identified. At example time slice y 224b illustrated at FIG. 2B, objects 230c2 and 230d2 may be identified as associated with tracked object 230b2. Object 230c2 may be a belonging or other object being carried and/or worn by object of interest 230b2, such as luggage, clothing, etc. Object 230d2 may for example, have a social association with object 230b2, i.e. be a friend, family member, associate, accomplice, travel companion, and/or any other person having a social association with object of interest 230b2.

In the example illustrated at FIG. 2B, image capture device may capture an image at example time slice z 226b of object 230b2 passing object 230c2 to object 230a2. In this illustrated example, object 230b2 was not previously associated with object 230a2. In an example, system 200b may identify object 230a2 as associated with object 230b2 responsive to the passing of object 230c2 from object 230b2 to object 230a2. In an example implementation, system 200b may track object 230a2 and/or object 230c2 responsive to the passing of object 230c2 from object 230b2 to object 230a2.

In an example, system 200b may generate an alert 250 responsive to the passing of object 230c2 from object 230b2 to object 230d2 because object 230d2 was not identified as associated with object 230d2 at time slice y 224b. For example, in a high security area, such as an airport, passing belongings between associated members, such as travel companions, is typical and almost always innocuous. However, passing belongings between non-associated members and/or persons not travelling together may be considered to be suspicious activity and may be flagged for security monitoring. In an example, alert 250 may be recorded and otherwise stored at server 106b. Server 106b, in some examples, may transmit alert 250 to local and/or remote devices to notify relevant end-users, such as security officials, of the suspicious activity. In some examples, system 220b may identify any of objects 230b2, 230c2, and/or 230c3 as an object of interest responsive to either generating alert 250 or otherwise flagging the suspicious activity.

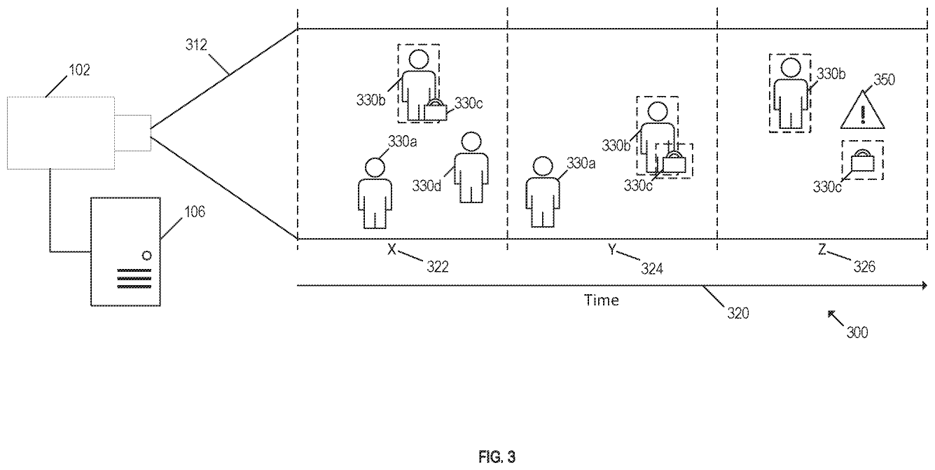

FIG. 3 is a block diagram illustrating an example system for generating an alert responsive to an event. System 300 may include similar architecture to that described above with respect to FIG. 1, including image capture device 102, and server 106. In this illustrated example, image capture device 102 may be disposed and/or otherwise positioned to have a field of view 312. Image capture device 102 may capture a time sequence 320 of images within the field of view 312 of image capture device 102. Specifically, image capture device 102 may capture an image at time slice x 322, time slice y 324, and time slice z 326.

Image capture device 102 may capture an image of objects 330a-d at time slice x 322. System 300 may track object 330b. Object 330b, and specifically the movement of object 330b, may be tracked across time sequence 320, as indicated by the images captured at time slice x 322, time slice y 324, and time slice z 326.

In an example, one or more objects associated with tracked object 330b may be identified. At example time slice y 224, object 330c may be identified as associated with tracked object 330b. Object 330c may be a belonging or other object being carried, transported, and/or worn by object of interest 330b, such as luggage, clothing, etc.

In the illustrated example of FIG. 3, image capture device 102 may identify a particular event, such as object 330b abandoning object 330c, and/or object 330b carrying and/or placing object 330c in a particular area. In an example implementation, system 300 may conduct machine learning techniques, such as deep learning object detection algorithms, face analytics, time-series analysis, computer vision techniques, object detection algorithms, any combination thereof, and/or any other learning algorithms for identifying object 330b as abandoned.

For example, object 330c may be identified as abandoned where object 330b separates from object 330c a threshold distance. In an example, object 330c may be identified as abandoned where object 330b separates from object 330c a threshold distance for a threshold period of time. In another example, object 330c may be identified as abandoned where object 330b has not been moved, or otherwise interacted with, e.g. by object 330b, for a threshold period of time.

For instance, as described in greater detail above, system 300 may “track” an object, including key points of an object, by monitoring the direction, position, speed, and/or any number of other attributes of the tracked object over a period of time. In an example implementation, the motions of a tracked object may be learned and further predicted based on historical data, such that suspicious events may readily be identified. In this illustrated example, object 330b is identified as abandoning object 330c at time slice z 326.

In an example, system 300 may generate an alert 350 responsive to identifying a suspicious event, such as the identified abandoned object 330c. In an example, server 106 may store a list of alert-triggering events (not shown). System 300 may, in some examples, generate an alert 350 when image capture device 102 captures an event on the list. In an example, alert 350, when triggered, may be recorded and otherwise stored at server 106. Server 106, in some examples, may transmit alert 350 to local and/or remote devices to notify relevant end-users, such as security officials, of the suspicious activity. In some examples, system 300 may identify any of objects 330b and/or 330c as an object of interest responsive to generating alert 350 or otherwise flagging the suspicious activity.

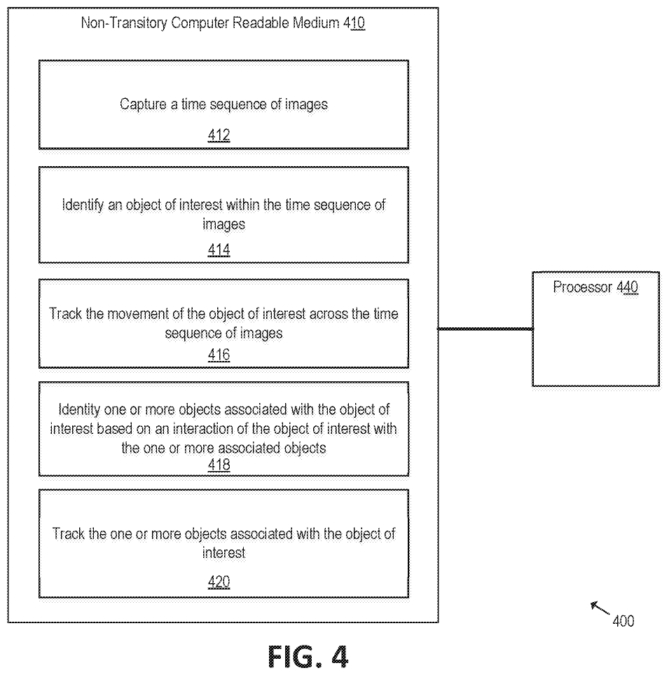

Server 106, including server 106a and/or 106b as described above, may in some examples include at least one non-transitory computer readable medium including instructions thereon for tracking one or more objects associated with an identified object, such as an object of interest. Server 106 may further include any number of processing resources. FIG. 4 is a block diagram 400 illustrating an example non-transitory computer readable medium 410 storing example instructions 412-420 thereon for tracking one or more objects associated with an object of interest. Although instructions 412-420 are described below with reference to system 100 of FIG. 1, this is for explanatory purposes and other suitable components for execution of instructions 412-420 may be utilized.

Non-transitory computer readable medium 410 may be implemented in a single device or distributed across devices. Likewise, processor 440 may represent any number of physical processors capable of executing instructions stored by computer readable medium 410.

As used herein, a “computer readable medium” may be any electronic, magnetic, optical, or other physical storage apparatus to contain or store information such as executable instructions, data, and the like. For example, any computer readable medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer readable medium described herein may be non-transitory. In examples described herein, a computer readable medium or media may be part of an article (or article of manufacture). An article or article of manufacture may refer to any manufactured single component or multiple components.

Processor 440 may be a central processing unit (CPU), graphics processing unit (GPU), microprocessor, and/or other hardware device suitable for retrieval and execution of instructions stored in computer readable medium 410. Processor 440 may fetch, decode, and execute program instructions 412-420, and/or other instructions. Similarly, processor 440 may fetch, decode, and execute program instructions 412-420. As an alternative or in addition to retrieving and executing instructions, processor 440 may include at least one electronic circuit comprising a number of electronic components for performing the functionality of instructions 412-420, and/or other instructions. Similarly, processor 440 may include at least one electronic circuit comprising a number of electronic components for performing the functionality of instructions 412-420, and/or other instructions.

Specifically, computer readable medium 410 may include instructions 412 to capture a time sequence of images. A time sequence of images may be a series of images taken in succession (often rapid succession), within a period of time. For example, as illustrated at FIG. 1, image capture device 102 and image capture device 104 may each capture a time sequence of images, including an image captured at time slice x 122, time slice y 124, and time slice z 126. While three examples time slices are illustrated for purposes of clarity and conciseness, any number of images may be captured within a period of time. For example, image capture device 102 and/or image capture device 104 may capture tens of images per second or even hundreds of images per second (often measured as frames-per-second “FPS”).

Computer readable medium 410 may include instructions 414 for identifying an object of interest within the time sequence of images. Referring to FIG. 1 as an example, image capture device 102 and/or 104 may capture any number of objects, i.e. any number of images containing the one or more objects. For instance, objects 130a-130g are captured within images taken by image capture devices 102 and 104 respectively at time slice x 122.

Among the objects captured by example image capture device 102 and/or 104, an object of interest may be identified. As described above, an object of interest may be a person of interest, for example an individual being investigated or otherwise monitored by police or other security persons, and/or a person identified as having conducted suspicious activity. In some example implementations, an object of interest may be pre-identified. For example, specific features of an object of interest may be stored at server 106 and an object matching those features may be identified by image captures device 102 and/or image capture device 104 via image detection algorithms. In another example implementation, server 106 may store any number of actions or activities, as are further described herein, that when executed by any of objects 130a-130h, will identify the executing object as an object of interest.

In an example implementation, server 106 may conduct machine learning techniques, such as deep learning object detection algorithms, face analytics, time-series analysis, computer vision techniques, object detection algorithms, any combination thereof, and/or any other learning algorithms for identifying an object as an object of interest.

Computer readable medium 410 may include instructions 416 for tracking a movement of the object of interest across the time sequence of images. Turning to FIG. 1, object 130d is indicated as being tracked by the dashed-line box surrounding person 130d. In some examples, instructions 416, when executed by processor 440, may “track” an object by monitoring the direction, position, speed, and/or any number of other attributes of the tracked object over a period of time. In an example implementation, the motions of a tracked object may be learned and further predicted based on historical data, such that the tracked object may be located quickly and automatically as the object moves through the area of interest. As illustrated in example FIG. 1, object of interest 130d, and specifically the movement of object of interest 130d, may be tracked across time sequence 120, as indicated by the images captured at time slice x 122, time slice y 124, and time slice z 126.

Computer readable medium 410 may include instructions 418 for identifying one or more objects associated with the object of interest. In the example illustrated at FIG. 1, objects 130e and 130f may be identified as associated with object of interest 130d at time slice y 124. Objects 130e and/or 130f may for example, have a social association with object 130d, i.e. be a friend, family member, associate, accomplice, travel companion, and/or any other person having a social association with object of interest 130d. In some examples, objects 130e and/or 130f may be a belonging or other object being carried and/or worn by object of interest 130d, such as luggage, clothing, etc.

In an example implementation, computer vision techniques, such as deep learning object detection algorithms, face analytics, key point analysis, and/or time series analysis of scene progressions adapted by computer vision algorithms may be utilized to identify objects 130e and/or objects 130f as associated with object of interest 130d. An object may, in some examples, be identified as associated with an object of interest based on an interaction of the object of interest with the associated object. Specifically, the association of objects may be identified, for example, by actions, movement patterns, and/or positioning patterns exhibited by object 130d, and in some examples by key points 130d1-d3 of object 130d, relative to objects 130e and/or objects 130f. For example, deep learning object detection algorithms may be utilized to identify an association between objects according to a relative proximity and/or contact between the objects over a period of time; by analyzing the actions taken between objects, e.g. a handshake, an embrace, a passing of a belonging, etc.; the length of time the objects are captured within a like field of view, and/or any number of other learned association patterns between objects.

Computer readable medium 410 may include instructions 420 for tracking the one or more objects associated with the object of interest. In an example implementation, tracking the one or more objects associated with the object of interest may include following the one or more associated objects across a second field of view where the one or more associated objects leave the first field of view. In an example, the one or more associated objects may be tracked at a second field of view even if the object of interest is not captured within the second field of view. Turning to time slice z 126 of the illustrated example, associated object 130f may be tracked even after leaving first field of view 112 of image capture device 102 and entering second field of view 114 of image capture device 104. Accordingly, any number of objects associated with an object of interest may be simultaneously tracked at different fields of view from a tracked object of interest.

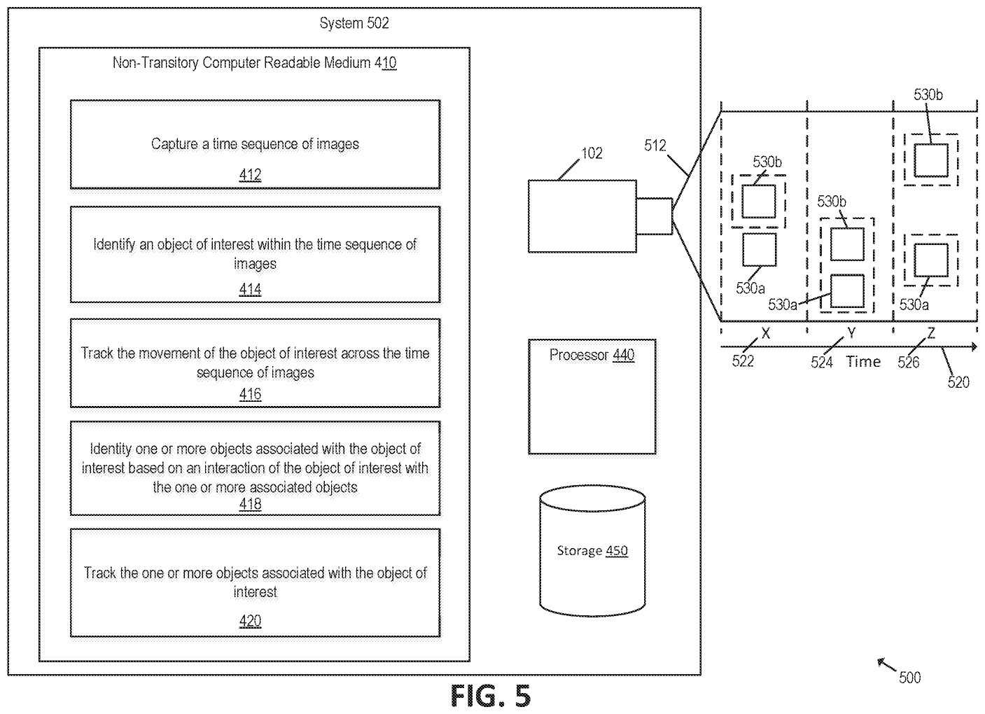

FIG. 5 is a block diagram 500 illustrating an example system 502 for tracking one or more objects associated with an object of interest. System 502 may include similar architecture to that described above with respect to FIG. 1 and FIG. 4, including example image capture device 102 of FIG. 1, processor 410 of FIG. 4, and non-transitory computer readable medium 410 of FIG. 4 including instructions 412-420 as further described above. System 502 may be a video surveillance system and may include a computing device, e.g. server 106 of FIG. 1, or multiple computing devices in communication over a network with one or more image capture devices.

As illustrated in FIG. 5, system may further include storage 450, which may be hardware for data storage, e.g. RAM, EEPROM, volatile memory, non-volatile memory, flash memory, a storage drive (e.g., an HDD, an SSD), any type of storage disc (e.g., a compact disc, a DVD, etc.), or the like, or a combination thereof. Although storage 450 is illustrated as a single component for purposes of clarity and conciseness, it may be understood that storage 450 may include any number of devices for storage of image data, metadata, generated insights, recorded and/or flagged alerts or events, etc. For example, storage 450 may be a searchable database and/or as any other data structure enabling the query, playback, and/or analysis of the data. Accordingly, system 502 may be hardware or a combination of hardware and software for image capture, object tracking, and real-time analytics.

In this example, system 502 includes image capture device 102, which, as described herein, captures image data, and specifically, a time sequence of images. In an example, image capture device 102 may pass image data to be stored at example storage 450. In an example, storage 450 may store image data received by image capture devices 102. Processor 440 may otherwise process and/or generate insights from the data stored at storage 450, and any generated insight may, in some examples, be stored at storage 450. In some examples, storage 450 may otherwise store the image data as video streams of data which may include complementary tracking metadata.

Image capture devices 102 may capture time sequence 520 of images within field of view 512. As described herein, a time sequence of images may be a series of images taken in succession (often rapid succession), within a period of time. For example, as illustrated at FIG. 5, image capture device 102 may capture an image at time slice x 522, time slice y 524, and time slice z 526.

The images captured by image capture device 102 may include any number of objects, which, as referred described herein, may be any person or thing that can be interpreted as a unit for purposes of image processing. Objects 530a and 530b are illustrated herein as examples. Starting at example time slice x 522, example objects 530a and 530b are illustrated as captured within field of view 512 of image capture device 102.

In this example, object 530b may be identified by system 502 as an object of interest. For example, storage 450 may include a list of objects of interest for tracking. In other examples, predefined movements, features, behaviors, triggering events, etc., stored at storage 450 may be associated with object 530b which may cause object 530b to be identified by system 502 as an object of interest. In general terms, system 502 may conduct machine learning techniques, such as deep learning object detection algorithms, face analytics, time-series analysis, computer vision techniques, object detection algorithms, any combination thereof, and/or any other learning algorithms for identifying object 530b as an object of interest.

System 502 may track object 530b, as indicated by the dashed-line box surrounding person 530b. In this illustrated example, object 530b may be tracked responsive to being identified as an object of interest for any of the reasons described above. As illustrated in FIG. 5, object of interest 530b may be tracked across time sequence 520, as indicated by the images captured at time slice x 522, time slice y 524, and time slice z 526.

In the example illustrated at FIG. 5, object 530a may be identified as associated with object of interest 530b at time slice y 524. In an example implementation, system 502 may utilize computer vision techniques, such as deep learning object detection algorithms, face analytics, key point analysis, and/or time series analysis of scene progressions adapted by computer vision algorithms to identify object 530a as associated with object of interest 530b. For example, system 502 may use deep learning object detection algorithms to identify an association between object 530a and 530b according to a relative proximity and/or contact between objects 530a and 530b over a period of time; by analyzing the actions taken between objects 530a and 530b, e.g. a handshake, an embrace, a passing of a belonging, etc.; the length of time the objects 530a and 530b are captured within a like field of view, and/or any number of other learned association patterns between objects 530a and 530b.

System 502, upon identifying object 530a as associated with object of interest 530b, may track object 530a. In an example implementation, object 530a and object 530b may be tracked simultaneously upon identifying object 530a as associated with object 530b. In an example, objects 530a and 530b may be tracked simultaneously, even where objects 530a and 530b separate across a distance as illustrated at time slice z 526. Where, as in some examples, tracked objects separate across different fields of view, as illustrated at time slice 126 of FIG. 1, objects may be tracked simultaneously by different image capture devices across the different fields of view.

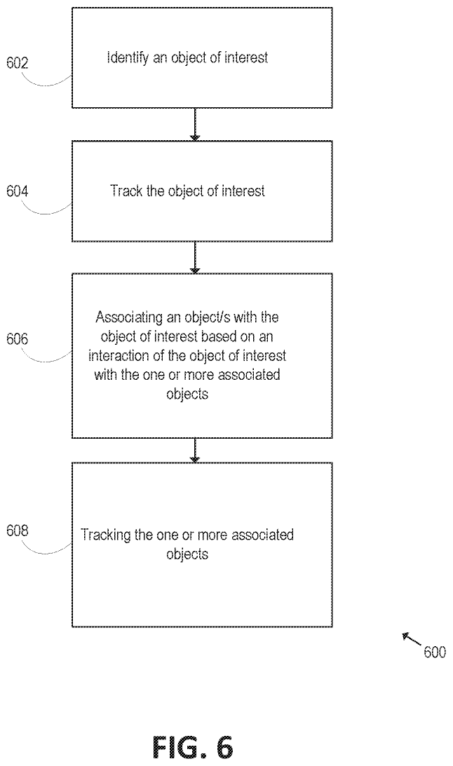

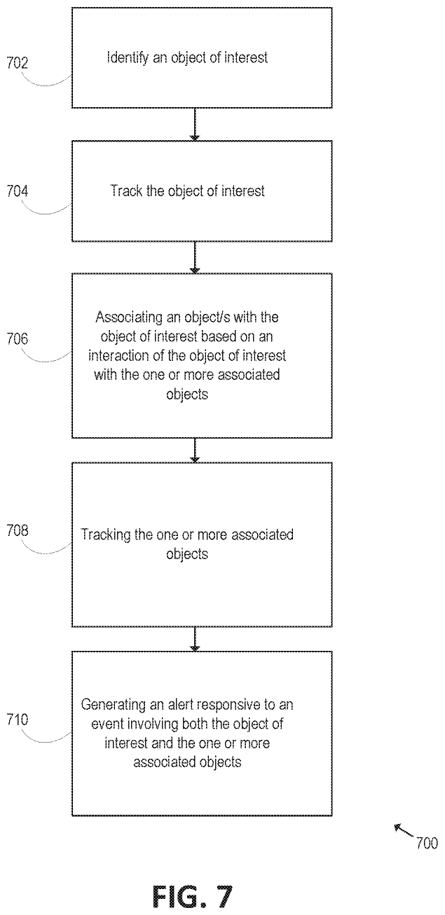

FIG. 6 and FIG. 7 are block diagrams illustrating example methods, 600 and 700 respectively, for tracking an object associated with an object of interest. Although execution of method 600 and 700 is described below with reference to system 502 of FIG. 5, this is for explanatory purposes and other suitable components for execution of method 600 and 700 may be utilized. Method 600 and 700 may be implemented in the form of executable instructions stored on a machine-readable storage medium and/or in the form of electronic circuitry, e.g. hardware. In some examples, steps of method 600 and 700 may be executed substantially concurrently or in a different order than shown in FIG. 6 and FIG. 7 respectively. In some examples, method 600 and method 700 may include more or less steps than are shown in FIG. 6 and FIG. 7 respectively. In some examples, some of the steps of method 600 and/or method 700 may, at certain times, be ongoing and/or may repeat.

Turning to FIG. 6, an object may be identified at block 602. For example, system 502 of FIG. 5 may be a video surveillance system that identifies object 530b as an object of interest. At block 604, the object of interest may be tracked. As illustrated in example FIG. 5, system 502 may track object of interest 530b across a time sequence 520 of images, i.e. time slice x 522, time slice y 524, and time slice z 526.

At block 606, one or more objects may be associated with the object of interest based on an interaction of the object of interest with the one or more associated objects. As further illustrated at FIG. 5, system 502 may associate object 530a with object 530b. As described above, the interaction of objects may be an action, movement pattern, and/or positioning pattern exhibited by the object of interest or the identified associated objects, and in some examples, the interaction of object may be identified through the movement patterns of specific key points of the object of interest or the identified associated objects, relative to each other. For example, a video surveillance system may use deep learning object detection algorithms to identify an association between objects according to a relative proximity and/or contact between objects over a period of time; by analyzing the actions taken between objects, e.g. a handshake, an embrace, a passing of a belonging, etc.; the length of time the objects are captured within a like field of view; and/or any number of other learned association patterns between objects.

At block 608, one or more objects associated with the object of interest may be tracked. For example, system 502 of FIG. 5 may, as described above, track object 530a associated with object 530b.

Turning to FIG. 7, an object of interest may be identified at block 702. At block 704, the object of interest may be tracked. At block 706, one or more objects may be associated with the object of interest based on an interaction between the object of interest and the one or more associated objects. At block 708, one or more objects associated with the object of interest may be tracked.

At block 710, an alert may be generated responsive to an event involving both the object of interest and the one or more associated objects. For example, an alert may be generated responsive to identifying a suspicious event, such as identified abandoned object 330c of FIG. 3. In some examples, the alert may be transmitted to local and/or remote devices to notify relevant end-users, such as security officials, of the suspicious activity. In some examples, any object/s associated with the suspicious event may be identified as an object of interest responsive to generating the alert.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A non-transitory computer readable medium comprising instructions that, when executed by a processor, causes the processor to:
capture, via an image capture device, a time sequence of images at a first field of view of the image capture device;
identify an object of interest within the time sequence of images;
track the object of interest across the time sequence images;
identify one or more objects associated with the object of interest based on an interaction between the object of interest and the one or more associated objects across the time sequence of images; and
track the one or more objects associated with the object of interest.

2. The computer readable medium of claim 1, wherein tracking the one or more objects associated with the object of interest includes tracking the one or more associated objects across a second field of view where the one or more associated objects leaves the first field of view.

3. The computer readable medium of claim 1, wherein tracking the one or more objects associated with the object of interest includes tracking the one or more associated objects across a second field of view different from the field of view at which the object of interest is tracked.

4. The computer readable medium of claim 3, wherein the first field of view is associated with a first image capture device at a first location and the second field of view is associated with a second image capture device at a second location different from the first location.

5. The computer readable medium of claim 1, wherein the object of interest is a person, and further comprising instructions to generate an alert responsive to the first person passing the object of interest to an object not of the one or more associated objects.

6. The computer readable medium of claim 1, wherein the interaction is determined by tracking a frame of the object of interest and identifying a particular movement of the object frame relative to the one or more associated objects.

7. The computer readable medium of claim 6, wherein the object of interest frame is a connected model of key points associated with the object of interest.

8. A method comprising:
identifying, by a video surveillance system, an object of interest;
tracking, by the video surveillance system, the object of interest;
associating one or more objects with the object of interest based on an interaction between the object of interest and the one or more associated objects captured by the video surveillance system; and
responsive to the association, tracking, by the video surveillance system, the one or more associated objects.

9. The method of claim 8, wherein the interaction includes a movement pattern of the object of interest relative to the one or more associated objects.

10. The method of claim 8, wherein the video surveillance system includes multiple image capture devices each having a field of view, and tracking the object of interest and the one or more associated objects includes tracking an object of interest and the one or more associated objects across the fields of view.

11. The method of claim 10, wherein the object of interest and the one or more associated objects are tracked across different fields of view responsive to the object of interest and the one or more associated objects separating across different fields of view.

12. The method of claim 8, further comprising generating an alert responsive to an event involving both the object of interest and the one or more associated objects.

13. The method of claim 12, wherein the event includes the object of interest separating from the one or more associated objects a threshold distance for a threshold period of time.

14. The method of claim 12, wherein the object of interest is a first person, and the event includes the first person passing the associated one or more objects to a second person.

15. The method of claim 14, wherein the second person is not any of the one or more associated objects.

16. A video surveillance system comprising:
a first image capture device having a first field of view for capturing a first time sequence of images at the first field of view; and
a computer readable medium including instructions, that, when executed by a processor:
captures, via the first image capture device, the first time sequence of images at the first field of view;
identifies an object of interest within the time sequence of images;
tracks the object of interest across the first time sequence of images at the first field of view;
identifies one or more objects associated with the object of interest based on an interaction between the object of interest and the one or more associated objects across the time sequence of images at the first field of view; and
tracks the one or more objects associated with the object of interest.

17. The video surveillance system of claim 16, wherein tracking the one or more objects associated with the object of interest includes tracking the one or more associated objects across a time sequence of images captured by a second capture device.

18. The video surveillance system of claim 17, wherein tracking the one or more objects associated with the object of interest includes tracking the one or more associated objects across the second field of view of the second capture device while simultaneously tracking the object of interest across the first field of view of the first capture device.

19. The video surveillance system of claim 16, further comprising instructions that, when executed by the processor, generate an alert responsive to an event involving both the object of interest and the one or more associated objects.

20. The video surveillance system of claim 16, wherein the event includes the object of interest separating from the one or more associated objects a threshold distance for a threshold period of time.
